(19) United States
(12) Patent Application Publication
(10) Pub. No.: US 2008/0035578 A1
(43) Pub. Date: Feb. 14, 2008

(54) Triple-tank system and method for treating water

(75) Inventor: Lawrence Robert Powers, Roscoe, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Bio-Water Technology, Inc., Roscoe, IL (US)

(21) Appl. No.: 11/545,293

(22) Filed: Oct. 10, 2006

Related U.S. Application Data
(60) Provisional application No. 60/837,548, filed on Aug. 14, 2006.

(51) Int. Cl. C02F 1/42

(52) U.S. Cl. 210/670; 210/275; 210/284

(57) ABSTRACT

Disclosed is a three-tank water treatment system. In operation, water flows through each tank in succession, with each tank performing one or more treatment operations. By allocating a separate tank for the copper/zinc redox alloy filtration medium, some embodiments of this system allow for a greater amount of the redox alloy to be deployed than is practical with existing systems. This increases the effectiveness of this type of filtering and increases the lifetime between necessary changes of the filtration media. In a preferred embodiment, the three tanks are placed in a vertical column. Each of the uppermost two tanks has one dome hole or bulkhead hole near its top and another near its bottom. When the time comes to exchange the filtration medium in a tank, the top and bottom holes are opened, and the media is easily drained out and replaced.

### CROSS-REFERENCE TO RELATED APPLICATION

This application claims priority to U.S. Provisional Patent Application 60/837,548, “Triple-Tank System and Method for Treating Water,” which was filed on Aug. 14, 2006, and which is incorporated herein by reference in its entirety.

### FIELD OF THE INVENTION

The present invention is related generally to water treatment, and, more particularly, to water-treatment systems using a redox alloy.

### BACKGROUND OF THE INVENTION

Water-treatment systems typically direct municipal or well water through a series of filtration stages where each stage filters out one or more undesirable elements found in the water. For example, there can be stages to soften the water, to remove iron and other heavy metals, to kill bacteria, and to remove organic chemicals and inorganic contaminants. A copper/zinc redox alloy can be used in one stage to reduce the amount of dissolved chlorine and to kill bacteria and other microorganisms.

Over time, contaminants accumulate in the filtration media and must be removed. To do this, the water-treatment system is periodically “backwashed” which releases contaminants from the filtration media and dumps them into a waste-water stream.

Even with periodic backwashing, filtration media eventually wear out and must be replaced. In existing systems, this is a messy and time-consuming process. To avoid this job, many systems are run long beyond their effective lives and begin to produce water of lesser quality.

### BRIEF SUMMARY OF THE INVENTION

In view of the foregoing, the present invention provides a three-tank water treatment system. In operation, water flows through each tank in succession, with each tank performing one or more treatment operations. By allocating a separate tank for the copper/zinc redox alloy filtration medium, some embodiments of this system allow for a greater amount of the redox alloy to be deployed than is practical with existing systems. This increases the effectiveness of this type of filtering and increases the lifetime between necessary changes of the filtration media.

In a preferred embodiment, the three tanks are placed in a vertical column. Each of the uppermost two tanks has one dome hole or bulkhead hole near its top and another near its bottom. When the time comes to exchange the filtration medium in a tank, the top and bottom holes are opened, and the media is easily drained out and replaced. (In some embodiments, the lowermost tank has only the one hole near its top. The filtration medium is replaced by vacuuming out the old medium and then pouring in the new medium.)

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a perspective view of the outside of a three-tank water-treatment system according to one embodiment of the present invention;

FIG. 2 is a cut-away view of the water-treatment system of FIG. 1;

FIG. 3 is a cut-away view of an alternative embodiment of the water-treatment system of FIG. 2;

FIG. 4 is a structural view of the screen and coupler between the tanks;

FIG. 5 is a flowchart of a method for treating water according to one embodiment of the present invention; and

FIG. 6 is a flowchart of a method for backwashing a water-treatment system.

### DETAILED DESCRIPTION OF THE INVENTION

Turning to the drawings, wherein like reference numerals refer to like elements, the present invention is illustrated as being implemented in a suitable environment. The following description is based on embodiments of the invention and should not be taken as limiting the invention with regard to alternative embodiments that are not explicitly described herein.

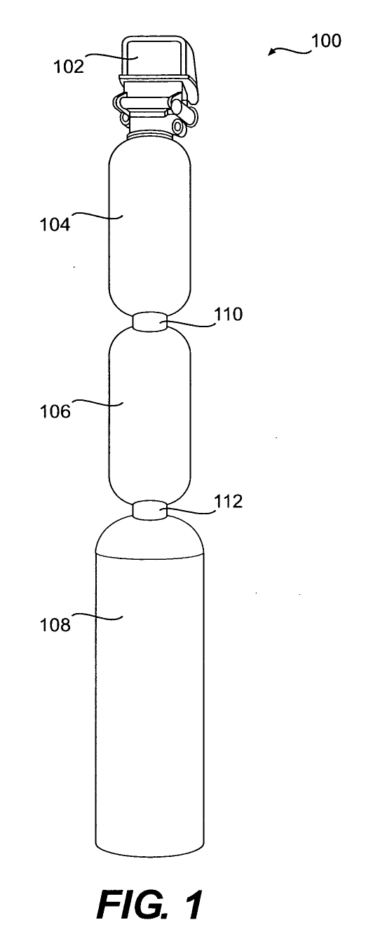

FIG. 1 is an outside view of a three-tank water-treatment system 100 according to the present invention. Sitting on top is a valve assembly 102. The valve assembly 102 includes connection ports (not shown) (1) to a source of water to be treated (e.g., water from a municipal water supplier), (2) to an output for treated water (e.g., to pipes that supply a home or an office), and (3) to a drain for waste water used during backwashing (e.g., a municipal sewer.) Inside the valve assembly 102 are valves (also not shown) that direct the flow of water through the water-treatment system 100. The operation of these ports and valves is discussed below. In some embodiments of the present invention, the valve assembly 102 is taken from the existing art and thus need not be described in detail here.

Below the valve assembly 102 (in the embodiment of FIG. 1) is a stack of three tanks 104, 106, and 108. Tanks 104 and 106 are connected to one another by a coupler 110. Tanks 106 and 108 are similarly connected to one another by a second coupler 112.

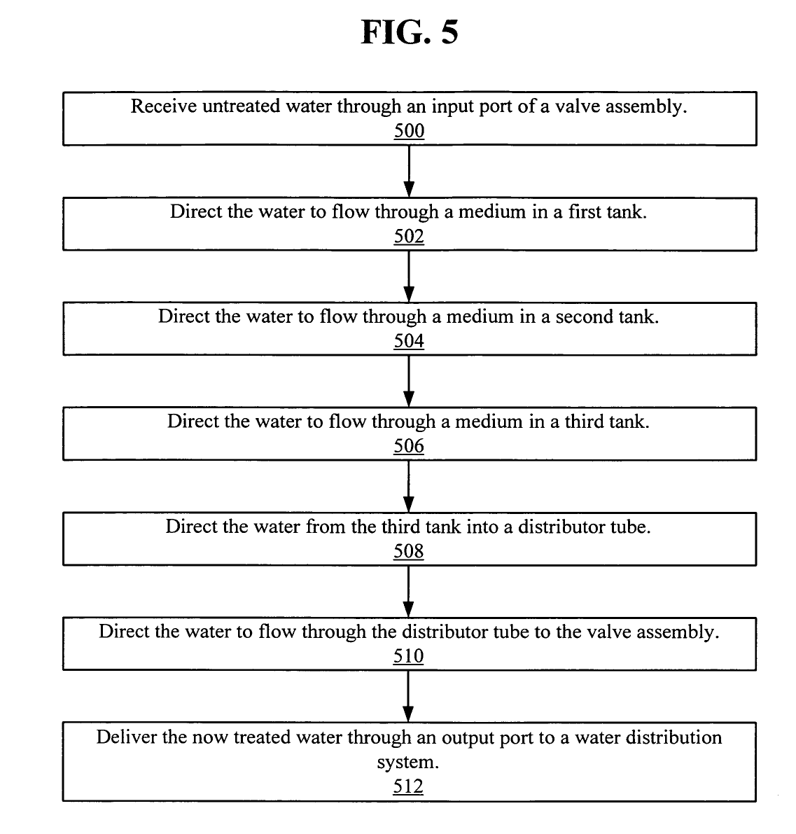

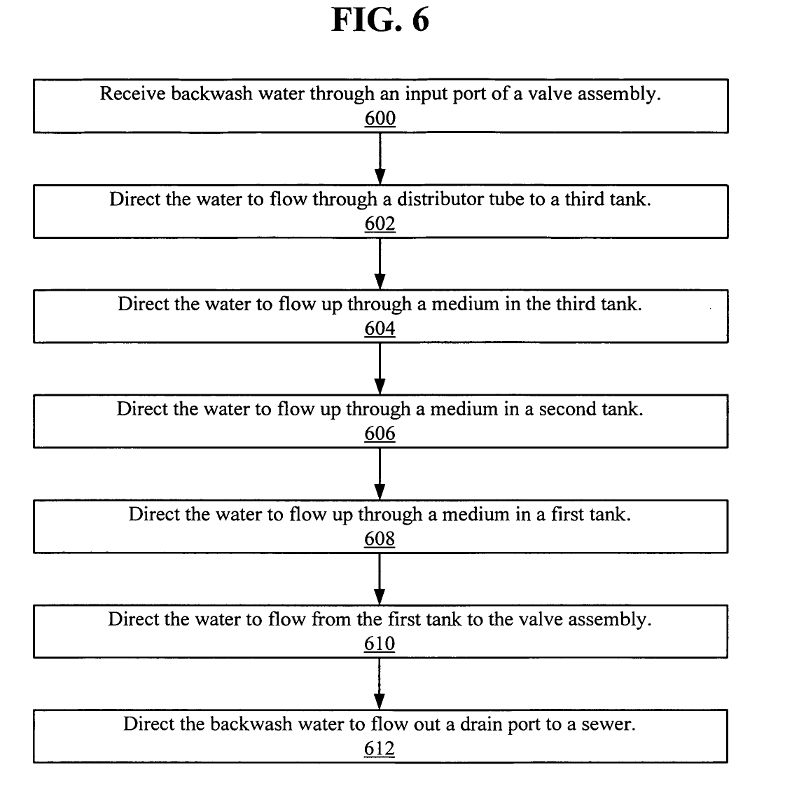

As described in more detail below (see FIGS. 5 and 6 and the accompanying text), the water-treatment system 100 generally operates in two modes. The “treatment” mode is used to produce treated water, while the “backwash” mode regenerates the media in the tanks 104, 106, and 108. In the treatment mode, the valve assembly 102 takes in water to be treated. The water is then directed to flow successively through the three tanks 104, 106, and 108. Each tank 104, 106, and 108 contains one or more mechanisms for treating the water as it passes through. For a non-limiting example, the tank 104 contains a copper/zinc redox alloy (such as KDF® marketed by KDF Fluid Treatment, Incorporated, of Three Rivers, Mich.), the tank 106 contains an activated carbon filtering medium, and the tank 108 contains an ion-exchange resin or a nano-technology medium (and possibly also contains gravel). These treatment mechanisms and others are all known in the art, and all may be used in conjunction with the present invention. After being treated successively in the three tanks 104, 106, and 108, the water is directed by the valve assembly 102 to the output port where it is distributed for use.

In the backwash mode of operation (often scheduled at night when there is little or no demand for treated water), the valve assembly 102 directs backwash water through the three tanks 104, 106, and 108 in succession, but usually in the opposite direction than in the treatment mode. The backwash water regenerates or backwashes the treatment mechanisms in the three tanks 104, 106, and 108 as is well known in the art. The backwash water is then directed by the valve assembly 102 to the drain port.

The physical arrangement of the water-treatment system 100 of FIG. 1 is illustrative only. Many other physical arrangements are possible in keeping with the structure and operation of the invention as claimed. The particular arrangement shown in FIG. 1 is often preferred because it takes up exactly the same amount of floor space as do many prior-art water-treatment systems. This arrangement thus eases the replacement of a prior-art system with a system according to the present invention.

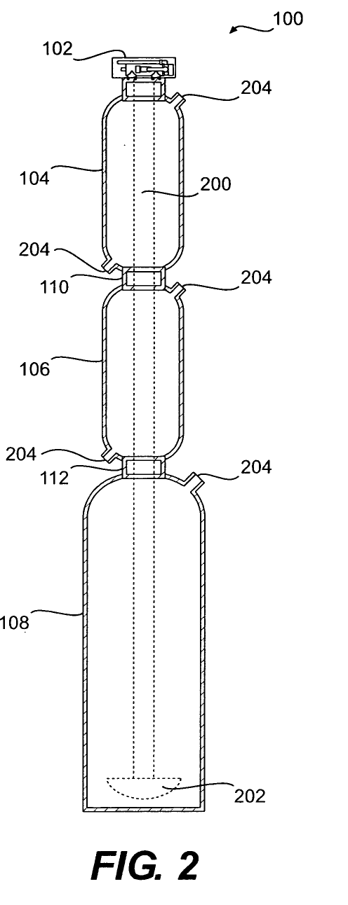

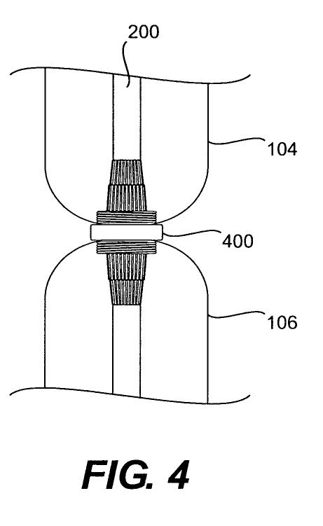

In the embodiment of FIG. 2, the water-treatment system 100 of FIG. 1 is cut-away to shown its internal structure. Running from the valve assembly 102 through the three tanks 104, 106, and 108 is a distributor tube 200. (More of the internal structure of this embodiment is shown in FIG. 4 and described in the accompanying text.)

The operation of the water-treatment system 100 is now described with reference to the structure of FIG. 2 and the method illustrated in FIG. 5. When in treatment mode, the valve assembly 102 receives untreated water through an input port (step 500 of FIG. 5) and directs the untreated water to flow into the top tank 104 (step 502). (Generally, water is “directed” simply by opening and closing valves in the valve assembly 102. Water pressure from the water delivery system then causes the water to flow in the desired path.) The water is filtered or otherwise treated by the medium in the top tank 104 (step 502) and then flows through the coupler 110 into the second tank 106, the water passing around, and not entering into, the distributor tube 200 (step 504). In a like manner, the water passes through the media in tanks 106 and 108 where it is further treated (steps 504 and 506). When the now treated water reaches the bottom of the lowermost tank 108, it flows into the end 202 of the distributor tube 200 (step 508). The treated water flows up the distributor tube 200 to the valve assembly 102 (step 510). From there, the treated water flows out the output port of the valve assembly 102 to distribution pipes and ultimately to faucets and the like (step 512).

When the water-treatment system 100 is in backwash mode, the valve assembly 102 receives water through an input port (step 600 of FIG. 6) and directs the water to flow down the distributor tube 200 (step 602). The water does not come into contact with the media in any of the tanks 104, 106, and 108 until it reaches the end 202 of the distributor tube 200. There, the water flows into the lowermost portion of the medium in the lowermost tank 108 (step 602). The water is forced to flow up through the medium of this tank (step 604), through the coupler 112, and into the tank 106 (step 606). (Note that the backwash water flows “up” in the embodiment of FIG. 2, but that in general the tanks 104, 106, and 108 can be arranged in a manner different from the vertical stack shown.) In like manner, the water flows up through the media of the upper two tanks 106 and 104 (steps 606 and 608). When the backwash water leaves the top tank 104 and reaches the valve assembly 102 (step 610), it is directed to a drain port and then out to a sewer (step 612). During this backwash operation, impurities collected by the media in the tanks 104, 106, and 108 are removed and pass into the drain. Also, the reverse flow of water through the media helps to “fluff up” the media, breaking up clumps that may form which would reduce the effective surface area of the media and decrease performance.

As is well known in the art, the media used in water treatment eventually lose their potency and need to be replaced. In the embodiment of FIG. 2, dome holes 204 are placed at the top and bottom shoulders of the top 104 and middle 106 tanks and on the top shoulder of the lowermost tank 108. In normal operation, these domes holes are closed with plugs. They are opened in order to easily replace the media in the tanks 104, 106, and 108. To replace the medium in one of the two upper tanks 104 and 106, the top and bottom dome holes 204 of the tank are opened, the old medium flows out the bottom dome hole 204, and the new medium is poured (or pumped) in through the top dome hole 204. The lowermost tank 108 shown in the embodiment of FIG. 2 has a flat bottom (or “foot” or “stand”) rather than a lower shoulder in order to securely support the weight of the entire water-treatment system 100 on a floor. Therefore, the lowermost tank 108 makes do without a lower dome hole 204. To replace the medium in this tank 108, its upper dome hole 204 is opened, the old medium is vacuumed out, and the new medium is then poured in. While this is less convenient than the procedure usable with the upper two tanks 104 and 106, it is acceptable in most installations because the lowermost tank 108 can be sized to include enough medium that it need not be replaced often.

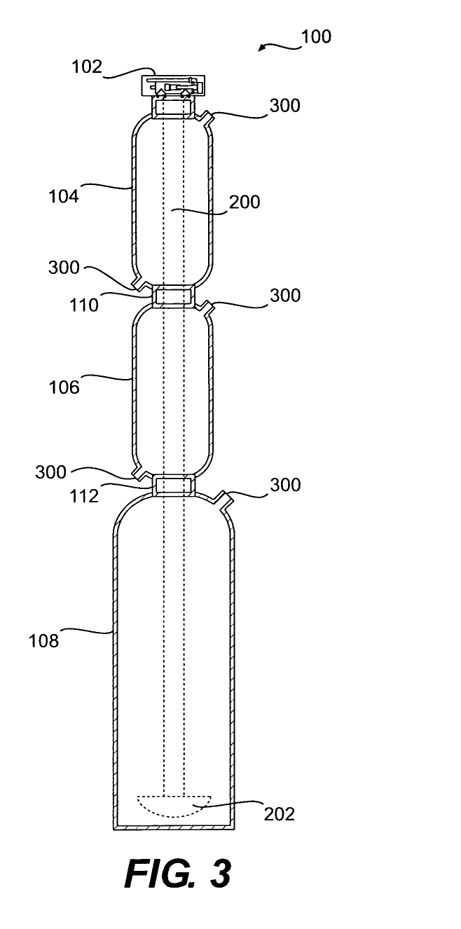

FIG. 3 is an alternative to the embodiment of FIG. 2. Instead of the dome holes 204, the tanks 104, 106, and 108 include bulkheads 300 with plugs. When replacing the medium in the tank, the bulkheads 300 are used in the same manner as the dome holes 204 discussed above. The choice between dome holes 204 and bulkheads 300 can be based on a number of well known engineering factors, including the curvature and area of the shoulders of the tanks 104, 106, and 108.

For clarity's sake, FIGS. 2 and 3 do not show media screens inside the tanks 104, 106, and 108. FIG. 4 shows such a media screen 400 between the tanks 104 and 106. This screen 400 is preferably made of plastic. During normal operation (when the water flows down from the tank 104 to the tank 106), the water flows down through the screen 400, but the screen 400 prevents the treatment medium in tank 104 from flowing into the tank 106. During backwash operation (when the water flows up from the tank 106 to the tank 104), water flows up through the screen 400, while the screen 400 prevents the treatment medium in tank 106 from flowing into the tank 104. A similar screen 400 sits between the tanks 106 and 108. A somewhat differently configured screen (not shown) but serving the same purpose surrounds the end 202 of the distributor tube 200 in the lowermost tank 108. In some embodiments, another screen sits near the top of the top tank 104 to prevent medium from migrating into the valve assembly 102 especially if the water-treatment system 100 is turned over during shipping.

The present invention has many advantages over other water-treatment systems. By allocating a separate tank, such as the top tank 104, to holding a copper/zinc redox alloy, the water-treatment system 100 can hold a significantly greater amount of that alloy than is practical in other systems. For example, in one embodiment of the water-treatment system 100, the top tank 104 holds thirty five pounds of copper/zinc redox alloy as compared with about two pounds held by other systems. In an average household, this increases the replacement period of this alloy from about a year to seventeen years. In the vertical-stack embodiment illustrated in FIGS. 1 through 3, this increased replacement period is gained without increasing the footprint needed by the water-treatment system 100. Thus, embodiments of the present invention can truly deliver “bottled-quality” water to every faucet in a home or small business without undue increases in maintenance or space requirements over existing systems.

In view of the many possible embodiments to which the principles of the present invention may be applied, it should be recognized that the embodiments described herein with respect to the drawing figures are meant to be illustrative only and should not be taken as limiting the scope of the invention. Those of skill in the art will recognize that some implementation details, such as the selection and placement of the treatment media in the tanks, are determined by specific situations. Therefore, the invention as described herein contemplates all such embodiments as may come within the scope of the following claims and equivalents thereof.

We claim:

1. A system for treating water, the water-treatment system operative in a treatment mode to receive untreated water through an input port and to deliver treated water through an output port, the water-treatment system also operative in a backwash mode to receive backwash water through the input port and to deliver waste water through a drain port, the water-treatment system comprising:
a valve assembly comprising the input port, the output port, and the drain port;
a first tank in fluid communication with the valve assembly;
a second tank in fluid communication with the first tank; and
a third tank in fluid connection with the second tank.

2. The water-treatment system of claim 1 wherein the first tank contains a copper/zinc redox alloy.

3. The water-treatment system of claim 2 wherein the copper/zinc redox alloy is KDF®.

4. The water-treatment system of claim 1 wherein the second tank contains carbon.

5. The water-treatment system of claim 1 wherein the third tank contains an element selected from the group consisting of: an ion-exchange resin and a nano-technology medium.

6. The water-treatment system of claim 1 wherein the first tank comprises two dome holes.

7. The water-treatment system of claim 1 wherein the first tank comprises two bulkheads with plugs.

8. The water-treatment system of claim 1 wherein the second tank comprises two dome holes.

9. The water-treatment system of claim 1 wherein the second tank comprises two bulkheads with plugs.

10. The water-treatment system of claim 1 wherein the third tank comprises one dome hole.

11. The water-treatment system of claim 1 wherein the third tank comprises one bulkhead with a plug.

12. The water-treatment system of claim 1 further comprising a distributor tube in fluid communication with the output port;
wherein the water-treatment system is operative in the treatment mode to receive untreated water through the input port, to direct water from the input port to the first tank, to direct water from the first tank to the second tank, to direct water from the second tank to the third tank, to direct water from the third tank to the distributor tube, and to deliver water from the distributor tube through the output port; and
wherein the water-treatment system is operative in the backwash mode to receive backwash water through the input port, to direct water from the input port to the distributor tube, to direct water from the distributor tube to the third tank, to direct water from the third tank to the second tank, to direct water from the second tank to the first tank, and to deliver water from the first tank through the drain port.

13. The water-treatment assembly of claim 12 further comprising:
a first coupler connecting the first tank to the second tank; and
a second coupler connecting the second tank to the third tank.

14. The water-treatment system of claim 13 further comprising:
a first screen assembly attached to the distributor tube where the distributor tube meets the valve assembly;
a second screen assembly attached to a top and a bottom of the first coupler; and
a third screen assembly attached to a top and a bottom of the second coupler;
wherein the first, second, and third screen assemblies prevent migration of media among the first, second, and third tanks.

15. A method for treating water, the method comprising:
(a) providing a system for treating water, the water-treatment system operative in a treatment mode to receive untreated water through an input port and to deliver treated water through an output port, the water-treatment system also operative in a backwash mode to receive backwash water through the input port and to deliver waste water through a drain port, the water-treatment system comprising:
a valve assembly comprising the input port, the output port, and the drain port;
a first tank in fluid communication with the valve assembly;
a second tank in fluid communication with the first tank;
a third tank in fluid connection with the second tank; and
a distributor tube in fluid communication with the output port;
(b) operating in the treatment mode, the treatment-mode operating comprising:
receiving untreated water through the input port;
directing water from the input port to the first tank;
directing water from the first tank to the second tank;
directing water from the second tank to the third tank;
directing water from the third tank to the distributor tube; and
delivering water from the distributor tube through the output port; and
(c) operating in the backwash mode, the backwash-mode operating comprising:
receiving backwash water through the input port;
directing water from the input port to the distributor tube;
directing water from the distributor tube to the third tank;
directing water from the third tank to the second tank;
directing water from the second tank to the first tank; and
delivering water from the first tank through the drain port.

16. The method for treating water of claim 15 wherein the first tank contains a copper/zinc redox alloy;
wherein the second tank contains carbon; and
wherein the third tank contains an element selected from the group consisting of: an ion-exchange resin and a nano-technology medium.

17. The method for treating water of claim 16 wherein the first tank comprises two dome holes, the second tank comprises two dome holes, and the third tank comprises one dome hole; and
wherein the method further comprises:
(d) using the two dome holes in the first tank to replace the copper-zinc redox alloy;
(e) using the two dome holes in the second tank to replace the carbon; and
(f) using the dome hole in the third tank to suck out the element in the third tank.

18. The method for treating water of claim 16 wherein the first tank comprises two bulkheads, the second tank comprises two bulkheads, and the third tank comprises one bulkhead; and
wherein the method further comprises:
(d) using the two bulkheads in the first tank to replace the copper-zinc redox alloy;
(e) using the two bulkheads in the second tank to replace the carbon; and
(f) using the bulkhead in the third tank to suck out the element in the third tank.
